(19) United States
(12) Patent Application Publication
(10) Pub. No.: US 2006/0186075 A1
(43) Pub. Date: Aug. 24, 2006

(54) Oval container with click closure

(75) Inventors: Dean Rainey, Clinton, CT (US); Gina Marie Pisa, Briarcliff Manor, NY (US); Jody Lea Wilson, Shelton, CT (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Home & Personal Care USA, Division of Conopco, Inc.

(21) Appl. No.: 11/064,704

(22) Filed: Feb. 24, 2005

(51) Int. Cl. B65D 55/02; A61J 1/00; A61J 1/03

(52) U.S. Cl. 215/202

(57) ABSTRACT

A container for a cosmetic composition is provided which includes an oval receptacle and replaceable cap. The receptacle is formed with a receiving cavity and near an open end thereof has an oval landing and projecting upward therefrom a centered round neck. A screwable thread is circumferentially molded along a wall of the neck. A stop projects outwardly perpendicular to the thread at a point near the landing. A rib projects from the neck at a point near an open end of the cavity. The cap is fitted with an oval skirt surrounding a circular closure, the latter features a screwable thread complimentary to and lockingly engagable with the screwable thread on the neck. An L-shaped catch on the lower edge of the neck prevents rotation of the cap when contacted with the stop. A tab on an upper edge of the circular closure engages with a tab on the cap producing an audible click as one overrides the other.

### BACKGROUND OF THE INVENTION

1. Field of the Invention

The invention relates to a container such as a jar with an outer oval shape along the closure perimeter of cap with body.

2. The Related Art

Oval containers have advantage over circular shaped equivalents. Consumers have a grip more naturally suited to the oval shape. Retailers find advantage in the larger frontage footprint of this shape; these containers present more of the brand advertising to attract shoppers.

Unlike round packaging, an ellipse presents engineering challenge. Rounded structures require no alignment. By contrast, a cap with an outer oval shape along a closure perimeter has only a few degrees of flexibility in seating onto a mating outer surface.

An audible signal would be desirable to cue the consumer that alignment has been achieved and proper closure attained. An audible cue would help consumers avoid over or under rotating cap during replacement onto the jar. Perfect alignment and protective closure would be the advantageous result of such a cue.

### SUMMARY OF THE INVENTION

A container for cosmetics is provided which includes:
an oval receptacle including a closed end and an open with a cosmetic composition receiving cavity therebetween, the cavity near the open end having an oval landing and a centered round neck projecting upward therefrom, the neck formed of a wall and a screwable thread circumferentially molded along the wall, the thread originating from a point near the open end of the receptacle and winding downward toward a point near the landing, the neck further including at the point near the landing at least one stop projecting outwardly perpendicular to the thread, and a rib projecting from the neck at the point near the open end;
a cap including an oval skirt surrounding a circular closure with opposite upper and lower edges, the closure having a wall formed with a screwable thread complimentary to and lockingly engageable with the screwable thread on the neck, at least one L-shaped catch formed on the lower edge preventing rotation of the cap upon contact with the at least one stop on the neck, a tab adjacent the upper edge and wherein an audible click is generated as the tab of the cap overrides the rib on the neck upon threading closure.

### BRIEF DESCRIPTION OF THE DRAWING

Various features and advantages of the present invention may better be understood with regard to the drawing in which:

FIG. 1 is a perspective view of the container in a closed position;

FIG. 2 is a perspective view of the container with cap removed from the receptacle;

FIG. 3 is a perspective view of the cap illustrating features on a circular closure therewithin; and

FIG. 4 is a perspective view of the container with cap removed.

### DETAILED DESCRIPTION OF THE INVENTION

Now there has been discovered a mechanism for generating a soft click to operate as a cue to customers assuring them of a properly aligned oval cap and receptacle.

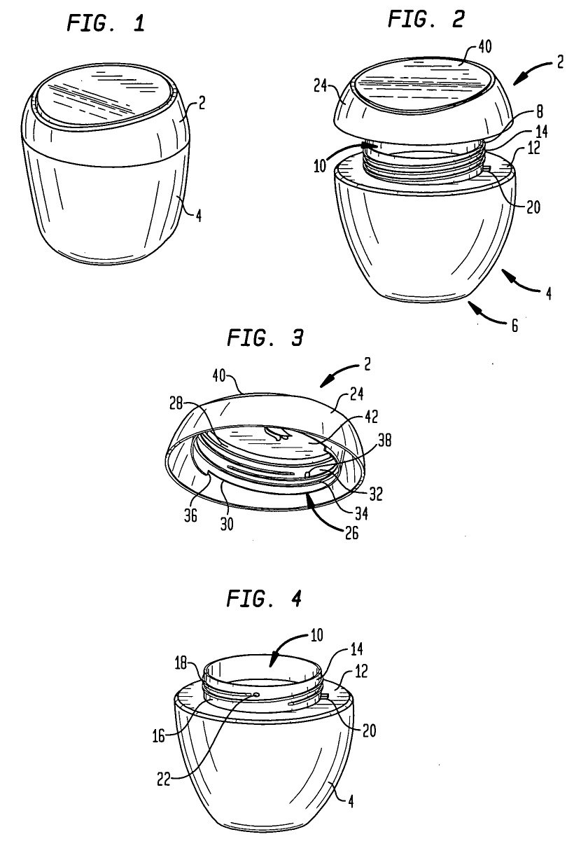

FIG. 1 illustrates the container with cap 2 and receptacle 4 in a closed position with alignment of all oval parts. FIG. 2 illustrates a situation wherein the cap has been removed from the receptacle. Featured on the receptacle is a closed end 6 and an open end 8 forming a receiving cavity 10, particularly for a cosmetic composition.

FIG. 4 provides a better illustration of the closure mechanism which is formed on the receptacle. Near the open end surrounding the cavity is an oval landing 12. Projecting upward therefrom is a centered round neck 14. Along a wall 16 of the neck is a circumferentially molded screwable thread 18. This thread originates from a point near the open end of the receptacle and winds downward to a point near the landing.

A stop 20 projects outwardly perpendicular to the thread at a point near the landing. A rib 22 projects from the neck at the point near the open end.

FIG. 3 illustrates cap 2 which is formed with an oval skirt 24 surrounding a circular closure 26 having upper and lower edges 28, 30. The closure is defined by a wall 32 formed with a screwable thread 34 complimentary to and lockingly engageable with the screwable thread 18 on the neck.

An L-shaped catch 36 is formed on the lower edge 30 of the closure. Rotation of the cap is prevented by the catch upon contact with the stop 20 on the neck. A tab 38 projects from the closure wall at a location adjacent the upper edge 28.

In the preferred embodiment shown in FIG. 2, the oval receptacle is molded as a unitary item through a plastics injection machine. A variety of plastics including polyolefins, polyamides, polyesters and polyvinyl chloride may all be utilized as construction materials. Particularly preferred is use of polypropylene. The cap is preferably non-unitarily molded. In the preferred embodiment, a roof 40 of the cap and circular closure 26 is bi-injected with the oval skirt 24 forming a one piece closure that may be molded in unlimited color combinations. In one embodiment the receptacle and closure are differently colored. An opaque flexible insert 42 may be positioned within the circular closure near the upper edge. The insert serves as a compressible liner to avoid leakage of any cosmetic composition arising from the inability to fully torque the cap into a fluid flow resistant seal. The reason for the partial torque is to allow the oval skirt and oval landing to align at the expense of complete torque seal. Cap and receptacle engage through the respective threads on walls of the closure and neck. Just prior to alignment of the oval skirt and oval landing, the tab of the cap overrides the rib on the neck. An audible sound characterized as a click will be heard by the operator. Immediately thereafter, the L-shaped catch 36 engages stop 20 to achieve alignment.

It should be understood that the invention may feature more than one L-shaped catch and respective stop. In the preferred embodiment, the number of catches and corresponding stops are two, each being approximately 180° apart on the respective circular closure and neck.

What is claimed is:

1. A container for cosmetic compositions comprising:
an oval receptacle comprising a closed end and an open with a cosmetic composition receiving cavity therebetween, the cavity near the open end having an oval landing a centered round neck and projecting upward therefrom, the neck formed of a wall and a screwable thread circumferentially molded along the wall, the thread originating from a point near the open end of the receptacle and winding downward toward a point near the landing, the neck further including at the point near the landing at least one stop projecting outwardly perpendicular to the thread, and a rib projecting from the neck at the point near the open end;
a cap comprising an oval skirt surrounding a circular closure with opposite upper and lower edges, the closure having a wall formed with a screwable thread complimentary to and lockingly engageable with the screwable thread on the neck, at least one L-shaped catch formed on the lower edge preventing rotation of the cap upon contact with the at least one stop on the neck, a tab adjacent the upper edge and wherein an audible click is generated as the tab of the cap overrides the rib on the neck upon threading closure.

2. The container according to claim 1 wherein the circular closure is formed of a transparent or translucent plastic while the oval skirt is opaque.

3. The container according to claim 2 wherein the circular closure has a color different from that of the oval skirt.

4. The container according to claim 1 further comprising a round flexible insert within the circular closure.

5. The container according to claim 1 wherein there are two L-shaped catches and two stops, each of the catches and stops being 1800 apart on the respective circular closure and neck.
